(19) United States
(12) Patent Application Publication
(10) Pub. No.: US 2008/0266078 A1
(43) Pub. Date: Oct. 30, 2008

(54) In-vehicle emergency call unit and in-vehicle emergency call system

(75) Inventor: Yoshio Koie, Handa-city (JM)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/900,898

(22) Filed: Sep. 13, 2007

(30) Foreign Application Priority Data
Sep. 15, 2006 (JP) 2006-250984

(51) Int. Cl. H04Q 7/00

(52) U.S. Cl. 340/539.13

(57) ABSTRACT

In accordance with the present disclosure, newly acquired position is transmitted to a service center to accurately provide a vehicle position when a starting trigger of an emergency call occurs even in a situation where position information is unobtainable from a navigation system. When a problem occurs in a navigation system or a communication line while the navigation system is running, and an in-vehicle emergency call unit becomes unable to receive position information from the navigation system, the in-vehicle emergency call unit saves position information that a positioning unit has acquired by autonomous positioning instead of position information received from and acquired by the navigation system. The in-vehicle emergency call unit then transmits to a service center the saved position information when a starting trigger occurs.

### CROSS REFERENCE TO RELATED APPLICATIONS

The present application is related to and claims priority from Unpublished Japanese Patent Application No. 2006-250984, filed Sep. 15, 2006, the contents of which are incorporated herein by reference.

### BACKGROUND OF THE INVENTION

1. Field of the Invention

The present invention relates to an in-vehicle emergency call unit disposed with an in-vehicle emergency call system and a navigation system and more specifically, to a unit and system configured to transmit position information to a call center when triggered by an emergency call.

2. Description of Background Art

In connection with a conventional in-vehicle emergency call system, a unit is provided that saves position information received from and acquired by a navigation system. When a starting trigger for an emergency call occurs, such as when an accident occurs, for example, an emergency call signal including the saved position information is transmitted, for example, to a service center as described in JP-A-2001-043469.

However, in a conventional configuration that receives position information that is acquired by a navigation system, problems can arise. For example, when a problem occurs in the navigation system or in a communication line such that the in-vehicle emergency call unit becomes unable to receive the position information acquired by the navigation system, the in-vehicle emergency call unit cannot transmit the newest position information to the service center when a starting trigger of an emergency call occurs and thus cannot accurately report the vehicle position.

### SUMMARY OF THE INVENTION

In view of the above circumstances, it is an object of the present invention to provide an in-vehicle emergency call unit and an in-vehicle emergency call system that can transmit to a service center position information whose positioning time is new and can report the appropriate vehicle position even when a starting trigger of an emergency call occurs in a situation where the in-vehicle emergency call unit is unable to receive position information from a navigation system.

In accordance with a first aspect of the in-vehicle emergency call unit of the invention, when position information is received from a navigation system by position information receiving means, control means causes the position information to be saved in position information saving means. When a starting trigger of an emergency call occurs, control means further causes an emergency call signal including the position information saved in the position information saving means to be transmitted from transmitting means to a service center for the purpose of an emergency call. When the position information receiving means has moved from a state where it is able to receive the position information from the navigation system to a state where it is unable to receive the position information from the navigation system while the navigation system is running, from then on the control means causes position information that is acquired by positioning means to be saved in the position information saving means.

Thus, when a problem occurs in the navigation system or a communication line, for example, and the in-vehicle emergency call unit becomes unable to receive the position information from the navigation system, the in-vehicle emergency call unit saves the position information that the positioning means has acquired by positioning instead of the position information that the position information receiving means receives, which is acquired by the navigation system. As a result, the in-vehicle emergency call unit can continue saving position information. From then on, even when a starting trigger of an emergency call occurs in a situation where the in-vehicle emergency call unit is unable to receive the position information from the navigation system, the in-vehicle emergency call unit can transmit to a service center position information whose positioning time is new, and can report the appropriate vehicle position.

In accordance with a second aspect of the in-vehicle emergency call unit of the invention, when the position information receiving means has returned from a state where it is unable to receive the position information from the navigation system to a state where it is able to receive the position information from the navigation system while the navigation system is running, the control means causes the position information received from the navigation system by the position information receiving means to be saved in the position information saving means. Thus, the in-vehicle emergency call unit can speedily return to the state before it became unable to receive the position information from the navigation system and, from then on, when a starting trigger of an emergency call occurs, the in-vehicle emergency call unit can transmit to the service center the position information received from the navigation system rather than the position information that the positioning means has acquired by positioning.

In accordance with a third aspect of the in-vehicle emergency call unit of the invention, the positioning means performs positioning just during time periods when the position information receiving means is unable to receive the position information from the navigation system while the navigation system is running. Thus, the running time of the positioning means while the navigation system is running can be kept to a necessary minimum, so that the overall power consumption of the in-vehicle emergency call unit can be controlled.

In accordance with a fourth aspect of the in-vehicle emergency call unit of the invention, the positioning means performs positioning for the purpose of an application other than an emergency call while the navigation system is stopped. Thus, the positioning means, which normally performs autonomous positioning for purposes other than an emergency call such as, for example, theft tracking while the navigation system is stopped, can be effectively utilized as a countermeasure when a problem occurs, such as when the in-vehicle emergency call unit has become unable to receive position information from the navigation system.

In accordance with a fifth aspect of the in-vehicle emergency call unit of the invention, the control means causes a signal including the position information acquired by the positioning means to be transmitted from the transmitting means while the navigation system is stopped. Thus, even when the vehicle has been stolen, for example, while the navigation system is stopped, the in-vehicle emergency call unit can perform theft tracking by transmitting a signal including position information.

### BRIEF DESCRIPTION OF THE DRAWINGS

FIG. 1 is a functional block diagram illustrating portions in accordance with various exemplary embodiments of the present invention;

FIG. 2 is a diagram illustrating saving of position information in accordance with various exemplary embodiments of the present invention; and

FIG. 3 is a flowchart illustrating positioning in accordance with various exemplary embodiments of the present invention.

### DETAILED DESCRIPTION OF THE INVENTION

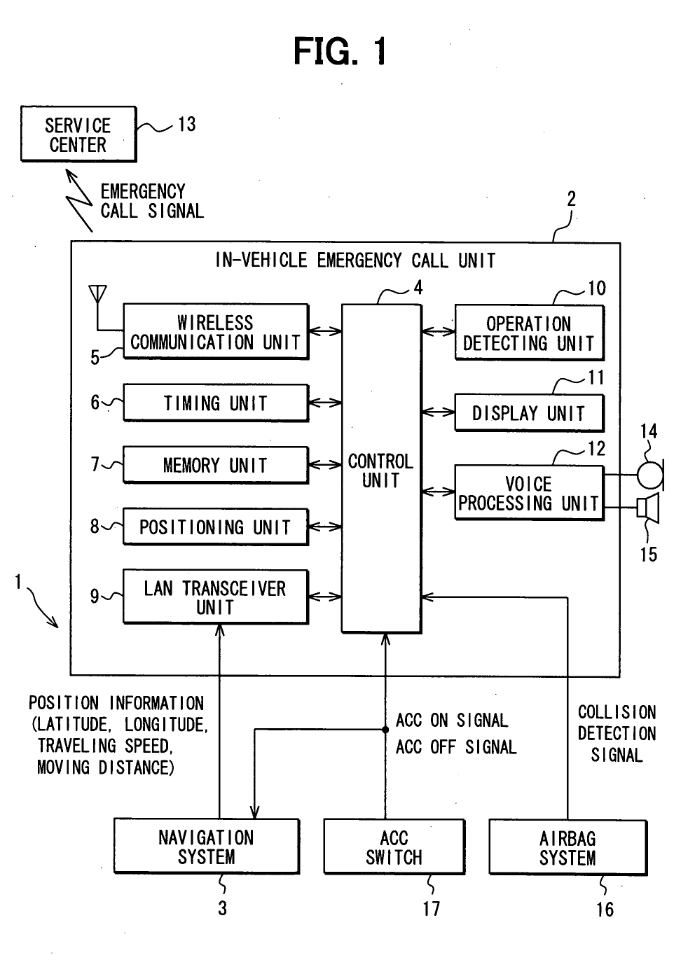

An embodiment of the present invention will now be described below with reference to the drawings. In FIG. 1, several components of an in-vehicle emergency call system 1 are shown. The in-vehicle emergency call system 1 includes an in-vehicle emergency call unit 2 and a navigation system 3. The in-vehicle emergency call unit 2 includes a control unit 4, which can act as a control means, a wireless communication unit 5, which can act as a transmitting means, a timing unit 6, a memory unit 7, which can act as a position information saving means, a positioning unit 8, which can act as a positioning means, a LAN transceiver unit 9, which can act as a position information receiving means, an operation detecting unit 10, a display unit 11, and a voice processing unit 12.

The control unit 4 includes a CPU as its main component and controls overall operation of the in-vehicle emergency call unit 2. The wireless communication unit 5 transmits an emergency call signal to a service center 13 via a wireless network when an emergency call command signal is inputted from the control unit 4. In the present case, various kinds of information, such as unit identification information for identifying the in-vehicle emergency call unit 2 and position information representing the vehicle position, are included in the emergency call signal.

The timing unit 6 performs timing when a timing command signal is inputted from the control unit 4. The positioning unit 8 acquires position information by autonomous positioning by receiving GPS radio waves transmitted from GPS satellites and calculating a parameter extracted from that GPS radio wave when a positioning command signal is inputted from the control unit 4. The LAN transceiver unit 9 includes the function of interfacing with an in-vehicle LAN. In the present embodiment, the LAN transceiver unit 9 transmits various kinds of information to, and receives various kinds of information from, the navigation system 3 and periodically receives position information (latitude, longitude, traveling speed, moving distance) from the navigation system 3, which is acquired by the navigation system 3 while running normally. In the present case, when the position information that the LAN transceiver unit 9 receives from the navigation system 3 and the position information that the positioning unit 8 acquires by autonomous positioning are compared, a vehicle speed signal and a gyro detection result are used in combination and the former is corrected by map matching, so the positional precision of the former is higher than that of the latter.

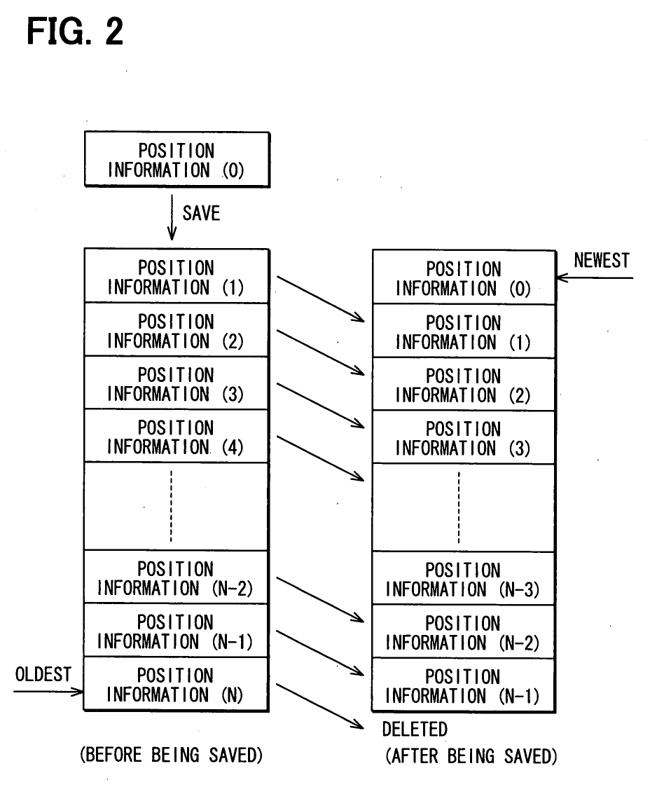

The memory unit 7 saves various kinds of information and saves the position information that the LAN transceiver unit 9 has received from the navigation system 3 and the position information that the positioning unit 8 has acquired by autonomous positioning. In the present case, as shown in FIG. 2, when the memory unit 7 saves the newest position information and the number of items of position information saved at that point in time is a maximum number of savable items (N number of items), then the memory unit 2 deletes the oldest position information of the position information and saves the newest position information.

The operation detecting unit 10 outputs an operation detection signal to the control unit 4 when a user operates an emergency call button. The display unit 11 displays display information corresponding to a display command signal when a display command signal is inputted from the control unit 4. The voice processing unit 12 processes transmitted voice that a microphone 14 has inputted and received voice that a speaker 15 outputs. In the present case, when a communication link is established between the in-vehicle emergency call unit 2 and the service center 13 as a result of the in-vehicle emergency call unit 2 transmitting an emergency call signal to the service center 13, the user can use the microphone 14 and the speaker 15 to speak with an operator disposed in the service center 13 and vocally request help or report on the severity of an accident.

An airbag system 16 detects a collision of the vehicle and outputs a collision detection signal to the control unit 4 when the impact of the collision is equal to or greater than a predetermined level. In the present case, the control unit 4 performs emergency call operation using, as a starting trigger of an emergency call, the fact that the operation detection signal has been inputted from the operation detecting unit 10 as a result of the user operating the emergency call button and the fact that the collision detection signal has been inputted from the airbag system 16.

An ACC (accessory) switch 17 outputs to the control unit 4 an ACC ON signal and an ACC OFF signal indicating whether or not that switch is ON or OFF. In the present case, when the ACC ON signal is inputted from the ACC switch 17, the control unit 4 causes the in-vehicle emergency call unit 2 to operate in a normal mode and enables reading of the position information from the navigation system 3, and when the LAN transceiver unit 9 receives the position information transmitted from the navigation system 3, the control unit 4 causes that position information to be saved in the memory unit 7. Further, when the ACC OFF signal is inputted from the ACC switch 17, the control unit 4 causes the in-vehicle emergency call unit 2 to operate in a low power consumption mode and disables reading of the position information from the navigation system 3. On the other hand, when a starting trigger of theft tracking, for example, occurs, then as theft tracking processing the control unit 4 outputs the positioning command signal to the positioning unit 8, causes the position information that the positioning unit 8 has acquired by autonomous positioning to be saved in the memory unit 7, and causes a theft tracking signal including that position information to be transmitted to the outside from the wireless communication unit 5.

It will be noted that in the above-described configuration, the in-vehicle emergency call unit 2 and the navigation system 3 are not limited to being interconnected via an in-vehicle LAN and may also be interconnected via a USB cable. Further, the navigation system 3 starts when the ACC ON signal is inputted from the ACC switch 17 and stops when the ACC OFF signal is inputted from the ACC switch 17.

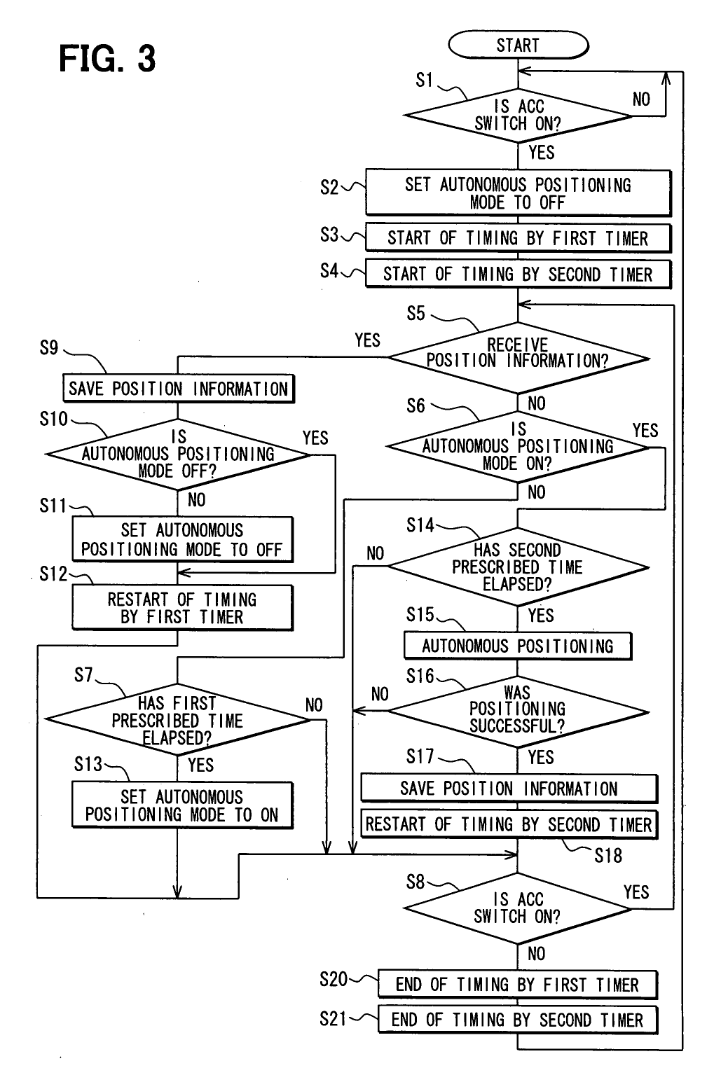

Next, the action of the above-described configuration will be described using FIG. 3.

In a state where the control unit 4 is causing the in-vehicle emergency call unit 2 to operate in the low power consumption mode, the control unit 4 determines whether the ACC switch 17 has been switched ON at S1. When the control unit 4 detects that the ACC switch 17 has been switched ON (YES at S1), then the control unit 4 causes the in-vehicle emergency call unit 2 to move from the low power consumption mode to the normal mode and sets an autonomous positioning mode to OFF at S2. Then, the control unit 4 causes a first timer to be started by the timing unit 6 at S3 and causes a second timer to be started by the timing unit 6 at S4. Here, the first timer measures a first prescribed time for determining whether or not the control unit 4 is incapable of receiving the position information from the navigation system 3, and the second timer measures a second prescribed time for ensuring positioning intervals during which the positioning unit 8 performs autonomous positioning.

Next, the control unit 4 determines whether or not the LAN transceiver unit 9 has received the position information from the navigation system 3 at S5, determines whether the autonomous positioning mode has been set to ON at S6, determines whether the first prescribed time has elapsed at S7, and determines whether the ACC switch 17 is ON at S8.

When the control unit 4 detects that the LAN transceiver unit 9 has received the position information from the navigation system 3 before the first prescribed time has elapsed in a state where the autonomous positioning mode is set to OFF and the ACC switch 17 is ON (YES at S5), then the control unit 4 causes the position information that the LAN transceiver unit 9 has received from the navigation system 3 to be saved in the memory unit 7 at S9.

Next, the control unit 4 determines whether or not the autonomous positioning mode is set to OFF at that point in time at S10. When the control unit 4 detects that the autonomous positioning mode is not set to OFF (NO at S10), then the control unit 4 sets the autonomous positioning mode to OFF at S11 and causes the first timer to be restarted by the timing unit 6 at S12. Then, the control unit 4 determines whether or not the ACC switch 17 is ON at S8, and when the control unit 4 detects that the ACC switch 17 is ON (YES at S8), then the control unit 4 returns to step S5 and repeatedly performs the processing from step S5 on.

Because of the above described exemplary procedures, when the in-vehicle emergency call unit 2 periodically receives the position information from the navigation system 3 while the ACC switch 17 is ON, that is, while the navigation system 3 is running, the in-vehicle emergency call unit 2 saves the position information received from the navigation system 3 as the newest position information.

In contrast, when the control unit 4 detects that the first prescribed time has elapsed before the LAN transceiver unit 9 receives the position information from the navigation system 3, for example as a result of a problem occurring in the navigation system 3 or a communication line, in a state where the autonomous positioning mode is set to OFF and the ACC switch 17 is ON (YES at S7), then the control unit 4 sets the autonomous positioning mode to ON at S13 and determines whether the ACC switch 17 is ON at S8. When the control unit 4 determines that the ACC switch 17 is ON (YES at S8), then the control unit 4 returns to step S5 and repeatedly performs the processing from step S5 on.

When the control unit 4 detects that the autonomous positioning mode is set to ON (YES at S6), then the control unit 4 determines whether or not the second prescribed time has elapsed at S14. When the control unit 4 detects that the second prescribed time has elapsed (YES at S14), then the control unit 4 outputs the positioning command signal to the positioning unit 8 and causes the positioning unit 8 to perform autonomous positioning at S15.

Next, the control unit 4 determines whether or not the positioning unit 8 has successfully performed autonomous positioning at S16. When the control unit 4 detects that the positioning unit 8 has successfully performed autonomous positioning (YES at S16), then the control unit 4 causes the position information that the positioning unit 8 has acquired by autonomous positioning to be saved in the memory unit 7 at S17 and causes timing by the second timer to be restarted by the timing unit 6 at S18. Then, the control unit 4 determines whether or not the ACC switch 17 is ON at S8. When the control unit 4 detects that the ACC switch 17 is ON (YES at S8), then the control unit 4 returns to step S5 and repeatedly performs the processing from step S5 on.

Because of the above described exemplary procedures, when the in-vehicle emergency call unit 2 no longer periodically receives the position information from the navigation system 3 while the ACC switch 17 is ON, that is, while the navigation system 3 is running, then the in-vehicle emergency call unit 2 receives position information as a result of the positioning unit 8 performing autonomous positioning and saves the position information that the positioning unit 8 has acquired by autonomous positioning as the newest position information.

It will be noted that, from then on, when the control unit 4 again detects that the LAN transceiver unit 9 has received the position information from the navigation system 3 (YES at S5) as a result of clearing the problem that had occurred in the navigation system 3 or restoration of the communication line, for example, then the control unit 4 again causes the position information that the LAN transceiver unit 9 has received from the navigation system 3 to be saved in the memory unit 7 at S9, and rapidly returns to processing as prior to the occurrence of the problem. Further, when the control unit 4 detects that the ACC switch 17 is not ON (NO at S8), then the control unit 4 causes the first timer to stop at S20, causes the second timer to stop at S21, returns to S1 and repeatedly performs the processing from S1 on.

As described above, according to the present embodiment, the in-vehicle emergency call unit 2 is configured such that when a problem occurs in the navigation system 3 or a communication line, for example, while the navigation system 3 is running and the in-vehicle emergency call unit 2 becomes unable to acquire the position information from the navigation system 3, then the in-vehicle emergency call unit 2 saves the position information that the positioning unit 8 has acquired by autonomous positioning instead of the position information received from the navigation system 3. Thus, the in-vehicle emergency call unit 2 can continuously save position information, so that from then on, even when a starting trigger of an emergency call occurs in a situation where the in-vehicle emergency call unit 2 is unable to receive position information from the navigation device 3, the in-vehicle emergency call unit 2 can transmit to the service center 13 position information whose positioning time is new and can report the appropriate vehicle position.

Further, the in-vehicle emergency call unit 2 is configured to save the position information received from and acquired by the navigation system 3 when the ability of the in-vehicle emergency call unit 2 to receive the position information from the navigation system 3 is restored. Thus, the in-vehicle emergency call unit 2 can speedily return to the state before it became unable to receive position information from the navigation system 3, and from then on, when a starting trigger of an emergency call occurs, can transmit to the service center 13 position information received and acquired from the navigation system 3.

Further, the in-vehicle emergency call unit 2 is configured such that the positioning unit 8 performs autonomous positioning just during time periods when a problem occurs in the navigation system 3 or a communication line, for example, while the navigation system 3 is running and the in-vehicle emergency call unit 2 is unable to receive position information from the navigation system 3. Thus, the running time of the positioning unit 8 while the navigation system 3 is running can be kept to a necessary minimum, so that the overall power consumption of the in-vehicle emergency call unit 2 can be controlled.

Moreover, the in-vehicle emergency call unit 2 is configured such that the positioning unit 8 performs autonomous positioning for the purpose of an application other than an emergency call, such as theft tracking, while the navigation system 3 is stopped. Thus, the positioning unit 8, which normally performs autonomous positioning for purposes other than an emergency call while the navigation system 3 is stopped, can be effectively utilized as a countermeasure when a problem occurs, such as when the in-vehicle emergency call unit 2 has become unable to receive position information from the navigation system 3, such as when the navigation system 3 is unable to acquire position information, or when position information acquired by navigation system 3 is unable to reach in-vehicle emergency call unit 2 due to problems with a communication line or the like.

The present invention is not limited to just the preceding embodiment and can be altered or expanded as follows.

Part of the in-vehicle emergency call unit may be configured based on the configuration requirements of the navigation system. For example, as an emergency call trigger, another signal may be applied other than the collision detection signal from the airbag system and the operation detection signal from the operation detecting unit 10 resulting from the user operating the emergency call button as described herein.

What is claimed is:

1. An in-vehicle emergency call unit comprising:
position information receiving means that receives position information from a navigation system; and
control means that causes the position information acquired from the navigation system by the position information receiving means to be saved in position information saving means and, when a starting trigger of an emergency call occurs, causes an emergency call signal including the position information saved in the position information saving means to be transmitted from transmitting means to a service center for the purpose of an emergency call,
wherein the in-vehicle emergency call unit includes positioning means that acquires position information by positioning,
wherein when the position information receiving means has moved from a state where it is able to acquire the position information from the navigation system to a state where it is unable to acquire the position information from the navigation system while the navigation system is running, from then on the control means causes the position information acquired by the positioning means to be saved in the position information saving means,
wherein when the position information receiving means has returned from a state where it is unable to acquire the position information from the navigation system to a state where it is able to acquire the position information from the navigation system while the navigation system is running, from then on the control means causes the position information acquired from the navigation system by the position information receiving means to be saved in the position information saving means, and
wherein when the position information receiving means has returned from a state where it is unable to acquire the position information from the navigation system to a state where it is able to acquire the position information from the navigation system while the navigation system is running, from then on the control means causes the position information acquired from the navigation system by the position information receiving means to be saved in the position information saving means.

2. The in-vehicle emergency call unit of claim 1, wherein the positioning means performs positioning just during time periods when the position information receiving means is unable to acquire the position information from the navigation system while the navigation system is running.

3. The in-vehicle emergency call unit of claim 1, wherein the positioning means performs positioning for the purpose of an application other than an emergency call while the navigation system is stopped.

4. The in-vehicle emergency call unit of claim 3, wherein the control means causes a signal including the position information acquired by the positioning means to be transmitted from the transmitting means while the navigation system is stopped.

5. An in-vehicle emergency call system comprising:
the in-vehicle emergency call unit of claim 1; and
a navigation system that transmits position information to the in-vehicle emergency call unit.

6. An in-vehicle emergency call unit comprising:
A network interface configured to receive first position information acquired by a navigation system;
storage device coupled to the network interface the storage device configured to save information as saved information;
wireless communication unit coupled to the network interface and the storage device;
control unit coupled to the wireless communication unit, the network interface and the storage device, the control unit including a processor, the processor configured to:
cause the first position information to be saved in the storage device as the saved information while the navigation system is running and the network interface is receiving the first position information; and
cause an emergency signal including the saved information to be transmitted from the wireless communication unit to a service center when a starting trigger occurs; and
positioning unit configured to acquire second position information by performing a positioning operation independent of the navigation system,
wherein, when the network interface moves from a first state of receiving the first position information while the navigation system is running to a second state of being unable to receive the first position information while the navigation system is running, the control unit causes the second position information to be saved in the storage device as the saved information, and
wherein, when the network interface returns from the second state to the first state while the navigation system is running, the control unit causes the first position information acquired by the navigation system and received by the network interface to be saved in the storage device as the saved information.

7. The in-vehicle emergency call unit of claim 6, wherein the positioning unit performs positioning only when the network interface is unable to receive the first position information while the navigation system is running.

8. The in-vehicle emergency call unit of claim 6, wherein the starting trigger includes a collision detection signal from an airbag system.

9. The in-vehicle emergency call unit of claim 6, wherein the starting trigger includes an activation of an emergency call button.

10. The in-vehicle emergency call unit of claim 6, wherein the positioning unit performs positioning to acquire the second position information while the navigation system is stopped.

11. The in-vehicle emergency call unit of claim 10, wherein the control unit is further configured to cause the second position information acquired by the positioning unit to be transmitted from the wireless communication unit while the navigation system is stopped.

12. The in-vehicle emergency call unit of claim 10, wherein the positioning unit performs positioning to acquire the second position information while the navigation system is stopped for a purpose other than transmitting the emergency signal to the service center when the starting trigger occurs.

13. A method for providing positioning information with an in-vehicle emergency call, the position information for locating a vehicle, the method comprising:
determining whether first position information has been received in an in-vehicle unit on a first end of a communication channel from an navigation system having an in-vehicle unit located on a second end of a communication channel,
enabling an autonomous acquisition of second position information by a positioning unit different from the navigation system if it is determined that the first position information has not been received from the navigation system,
autonomously acquiring second position information using the positioning unit, the positioning unit located in the vehicle on a different side of the communication channel from the navigation system,
disabling the autonomous acquiring of second position information from the positioning unit if the first position information has been received from the navigation system.

14. The method according to claim 13, further comprising:
storing one of the first position information it is determined that the first position information has been received, and the second position information if it is determined that the first information has not been received in a memory, and
transmitting the stored one of the first position information and the second position information to a service center.

15. The method according to claim 13, wherein the determining further includes:
detecting whether a first prescribed time has elapsed, the first prescribed time for receiving the first position information from the navigation system;
setting the positioning unit to ON if the first prescribed time has elapsed and the first position information has not been received;
detecting whether a second prescribed time has elapsed, the second prescribed time for ensuring positioning intervals during which the positioning unit performs autonomous positioning; and
causing the positioning unit to perform autonomous positioning to acquire the second position information if the second prescribed time has elapsed.

16. The method according to claim 14, wherein the storing includes:
determining whether the positioning unit has successfully performed autonomous positioning;
causing the second position information that the positioning unit has acquired by autonomous positioning to be stored in the memory;
determining whether the first position information has been received from the navigation system; and
causing the first position information to be stored in the memory if the first position information is received from the navigation system.

17. The method according to claim 13, wherein the autonomously acquiring the second position information is performed only when the first position information is not received from the navigation system to as to control the overall power consumption.

18. The method according to claim 13, wherein the autonomously acquiring second position information is performed for a purpose other than an emergency call, the purpose including theft tracking, while the navigation system is stopped.
